(19) United States
(12) Patent Application Publication
(10) Pub. No.: US 2007/0002811 A1
(43) Pub. Date: Jan. 4, 2007

(54) Mechanism to enable optimized provision of beacon information in WLAN networks

(75) Inventors: Stefano M. Faccin, Dallas, TX (US); Jari Jokela, Ylojarvi (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/433,094

(22) Filed: May 12, 2006

Related U.S. Application Data
(60) Provisional application No. 60/681,554, filed on May 12, 2005.

(51) Int. Cl. H04Q 7/24; H04L 12/56

(52) U.S. Cl. 370/338; 370/401

(57) ABSTRACT

A method and apparatus are set forth for providing a beacon in a network, including a Wireless Local Area Network (WLAN), such as that defined in IEEE 802.11 Standard Protocol, or one or more other networks, including a 3GPP, 3GPP2 or IEEE 802.16), featuring a technique for layering beacons so as to provide a first beacon having a set of information the access point (AP) needs to broadcast and a second beacon having a reduced set of information depending on the current system load. In one embodiment, the method includes layering the beacons as part of an interworking between the WLAN and the one or more of the other networks.

### CROSS-REFERENCE TO RELATED APPLICATIONS

This application claims to provisional patent application Ser. No. 60/681,554, filed 12 May 2005, which is hereby incorporated by reference.

### BACKGROUND OF THE INVENTION

1. Field of Invention

The present invention relates to a Wireless Local Area Network (WLAN) (e.g. defined in the IEEE 802.11 Protocol Specification). Specifically, the present invention refers to the standardization of solutions for interworking between WLAN and other networks (namely the third Generation Partnership Project (3GPP), 3GPP2 and IEEE 802.16 (related to Broadband Wireless Access)). The present invention refers also to the Media Independent Handoff (MIH) solutions being defined in the IEEE 802.21 Protocol Specification.

2. Problem in the Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wire LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, with distributed services through the AP using local distributed services set (DSS) or wide area extended services (ESS), as shown. In a WLAN system, end user access devices are known as stations (Non-AP STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCs. For instance, a UE1 in FIG. 2a may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. One of the RNCs will typically act as the “serving” or “controlling” RNC (SRNC or CRNC), while the other RNC will act as a “drift” RNC (DRNC). The mobile UEs are able to traverse the neighboring cells without having to re-establish a connection with a new Node B because either the Node Bs are connected to a same RNC or, if they are connected to different RNCs, the RNCs are connected to each other. During such movements of the mobile UE, it is sometimes required that radio links be added and abandoned in a handover situation so that the UE can always maintain at least one radio link to the UTRAN.

The interworking of the WLAN (IEEE 802.11) shown in FIG. 1 with other technologies (e.g. 3GPP, 3GPP2 or 802.16) such as that shown in FIGS. 2a and 2b is being defined at present in protocol specifications for 3GPP and 3GPP2. In IEEE protocol specification, such activities are carried out in IEEE 802.11 TGu and in IEEE 802.21 (the latter specification focusing specifically on the handoff of a device).

The interworking of these two types of networks or technologies can be split in two different scenarios:
Roaming: In such case, the STA connects to a new WLAN network, such as that shown in FIG. 1; and
Handoff: In such case, the same issues apply, but are more pressing since mobility must take place with minimal delay, including in a 3GPP/3GPP2 interworking scenario.

The interworking implies several aspects, but one of the major issues identified is network selection. Specifically, due to the current standards, the STA known in the art can discover very little about a WLAN network before authenticating and associating, where authentication is understood to be the process of determining the identity of a user accessing a system, and where association is understood to be the process of registering with a system or network to allow information to be transmitted and received with a device or system. In operation, a beacon signal is periodically transmitted (broadcast) from devices to identify their device and/or network to allow devices to determine which radio coverage area and device they are communicating with. However, the beacon signal and/or the content of Probe Response messages provide limited information, e.g.:

Both during roaming and handoff, the STA cannot discover whether the required connectivity is supported, e.g. IPv4 versus IPv6, connectivity to the Internet, type of protocols supported (e.g.), etc. (see document [1] below);

Both during roaming and handoff, identifying whether a certain WLAN network enables an STA to roam based on its belonging to a given operator is rather cumbersome (e.g. the STA must store a long list of Service Set Identities (SSIDs), and the list must be kept updated frequently); and

During handoff, it is essential for the STA to know whether it is entering a new domain and if the handoff entitles only an L2 handoff or requires a L3 handoff as well. Current solutions have shown to be inefficient and produce considerable delays. Some solutions have been proposed (see documents [3], [4] below).

Besides the interworking with other networks, availability of additional information to an STA regarding a certain network is needed in other scenarios. One example is mesh IEEE 802.11 networks, where different mechanisms for routing and security may be supported, the mesh network may or may not have connectivity to the Internet (i.e. “grounded” mesh versus “freestanding” mesh), and there can be other characteristics the STA needs to know before deciding whether or not to connect to the mesh network, and how to do so and what mechanisms to use.

In the past, several attempts took place to add new information to the WLAN beacon. The size of the beacon and the frequency at which it is sent impacts considerably the system capacity. Adding too much information to the beacon can be damaging (due to impact on the system capacity) and it would not be accepted easily in IEEE 802.11. Specifically, previous proposals that tried to create a new beacon information/type ([2]) were met with low acceptance in IEEE. Therefore modifications should be kept at a minimum. This implies that one cannot add all the information actually required to the beacon and let STAs discovery them by listening to the beacon.

The reader is referred to the following documents, which are hereby incorporated by reference in their entirety herein:

[1] “Network Characteristics for AP Selection”, documents IEEE 802.11-05/1595r0 and IEEE 802.11-05/1594r0, Airespace;

[2] “Adaptive Beaconing”, document 802.11-02/601r0, Nokia

[3] “Domain Identification for predictive handover among different domains”, Samsung, IEEE 802.11-04/711r0;

[4] “Access Router Identifier (ARID) for supporting L3 mobility”, Samsung, IEEE 802.11-04/710r0 [3] and [4] advocates that, when an handover takes place, the terminal needs to know whether it is moving between different domains (e.g. admin domains/security domains) and if a L3 handoff is needed (e.g. due to change of subnet) to speed up the detection of this. Specifically, document [4] advocates adding to the 802.11 beacon the AIRD (i.e. Access Router Identity) to allow the terminal to detect the change of subnet. It is believed this would not be efficient nor work in all cases, consistent with that provided in document [5] below; and

[5] Patent application Ser. No. 10/196,457 (NC17212/NC17213 by Stefano Faccin, describes a mechanism to enable optimized delivery of information to a terminal over a wireless link. Specifically, the idea therein is to avoid sending the whole IP Router Advertisement to the wireless terminals at the actual frequency it is generated by an Access Router. Instead, a functionality in the wireless point of attachment (e.g. the Access Point (AP) in WLAN or an access controller for WLAN) forwards to the terminals over L2 (e.g. the beacon in 802.11) only a subset of information (e.g. the subnet prefix) to allow the terminal to detect whether an L3 handover is implied when changing e.g. the access point (AP).

### SUMMARY OF THE INVENTION

The basic idea of the present invention is to define a scheme for distributing information to the terminals (e.g. similar to sending information through beacons) that allows to distribute complex sets of information in an optimized and adaptable way to minimize the system overhead.

The solution is based on the idea of layering beacons and layering the type of information (e.g. for Probe response message or Neighbor Report messages).

In its broadest sense, the present invention provides a method and apparatus for providing a beacon in a network, including a Wireless Local Area Network (WLAN), such as that defined in IEEE 802.11 Standard Protocol, or one or more other networks, including a 3GPP, 3GPP2 or IEEE 802.16), featuring a technique for layering beacons so as to provide a first beacon having a set of information the access point (AP) needs to broadcast and a second beacon having a reduced set of information depending on the current system load. In one embodiment, the method includes layering the beacons as part of an interworking between the WLAN and the one or more of the other networks. The present invention may form part of a network, a network node, a computer program product consistent with that described herein.

In particular, the present invention also provides a method for interworking between a Wireless Local Area Network (WLAN), including that defined in IEEE 802.11 Standard Protocol, and one or more other networks, including a 3GPP, 3GPP2 or IEEE 802.16), wherein the method includes layering beacons so as to provide a first beacon having a set of information the access point (AP) needs to broadcast and a second beacon having a reduced set of information depending on the current system load. In one embodiment, the first beacon is a full beacon containing a complete set of information the access point (AP) needs to broadcast and is sent at regular intervals when the system traffic load is below a certain threshold that is defined by a network administrator or specified by some other suitable mechanism, while the second beacon is a reduced beacon containing a subset of the information contained in the full beacon and is sent when the system traffic load is above a certain threshold at the same regular intervals the full beacon was sent in order to avoid impacting the system capacity. By way of example, the full beacon may include only relevant information, including information related to fast roaming, support for some .11k measurements, etc.

In effect, the layering of beacons includes using a two-layer set of information, including splitting the information to be provided to one or more stations (STA) in type-1 information and type-2 information. Information elements (Ies) are defined for all the type-1 information and all the type-2 information, the type-1 information is a semi-static set of the Ies, and the type-2 information is a more dynamic set of information, including providing the reduced beacon with type-2 information having an adaptive set of Ies based on the network deciding when and how to modify the content thereof. In operation, when the STA sends a request for such information, including in a probe request, the STA can indicate exactly what information it wants, so the response from the AP is customized to the request by the STA.

The method also includes sending the type-1 information and the type-2 information at different time intervals, including sending the type-1 information in the full beacon every X ms, and sending type-2 information in the reduced beacon every Y ms, and time intervals may be decided by an entity that is deploying access points (AP) in the network.

The method also includes the system monitoring requests by the STA and deciding, based on suitable management algorithms, to change the type of information sent and the frequency of sending the same, as well as creating an adaptive “advertising” of information—if an STA needs the information (either type-1 or type-2) more often, including if the STA did not get it at the last round it was distributed and therefore sends a request.

The scope of the invention is also intended to include a network having one or more network nodes for providing such layered beacons, including doing so as part of such an the interworking between such a WLAN and the one or more other network technologies, wherein the one or more network nodes such as an AP is configured to layer beacons so as to provide a full beacon and a reduced beacon depending on the current system load, as well as one or more network nodes such as a STA for receiving and/or requesting such a beacon signal and responding to the same.

Finally, the present invention is also intended to include a method having the one or more steps described herein performed in a computer program running on one or more processors or other suitable processing devices in one or more network nodes in such networks or systems, as well as a computer program product for one or more such network nodes, including for providing such an interworking between such networks.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 is a block diagram of an access point (AP) according to the present invention.

FIG. 4 is a block diagram of a station (STA) according to the present invention.

### DETAILED DESCRIPTION OF THE INVENTION

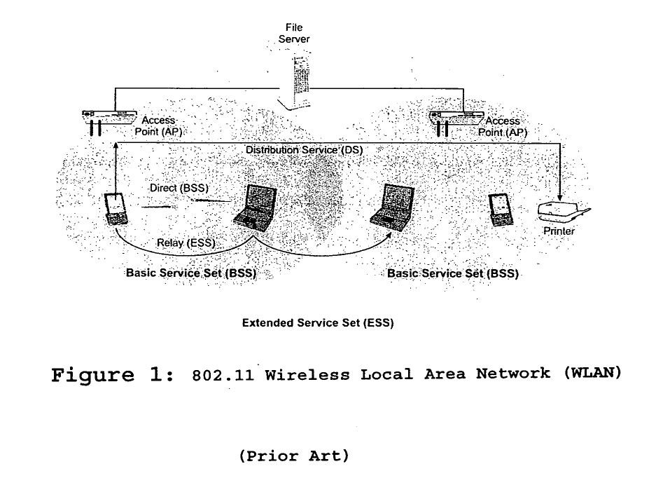

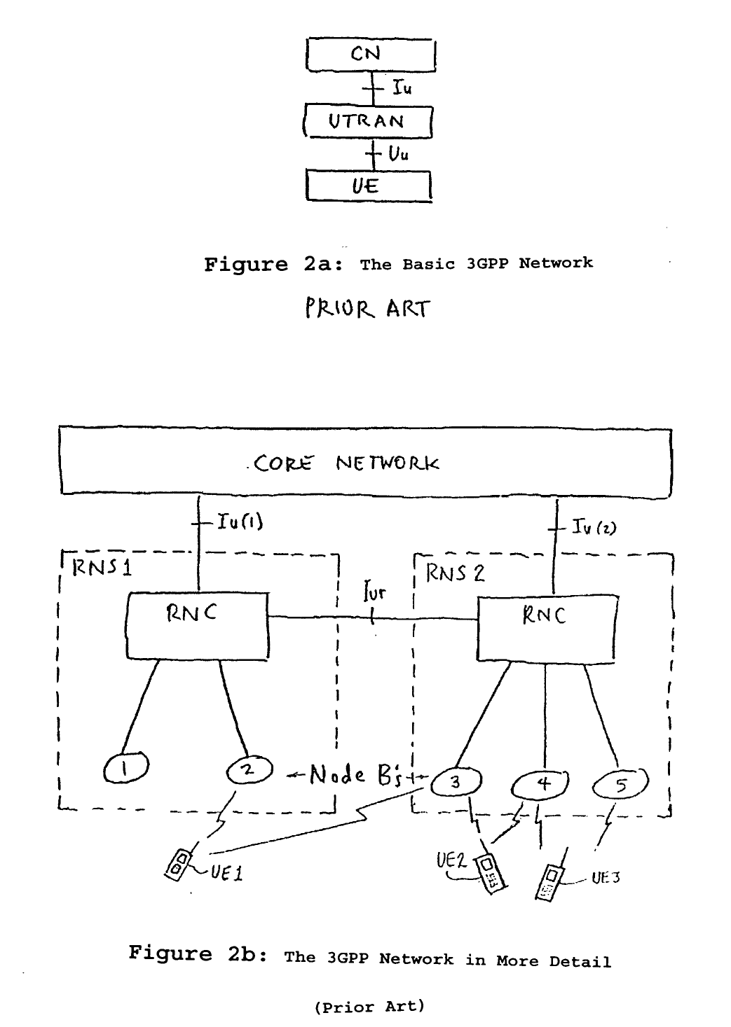

The present invention is described herein, by way of example, in relation to the interworking of the WLAN (IEEE 802.11) shown in FIG. 1 with other technologies (e.g. 3GPP, 3GPP2 or 802.16) such as that shown in FIGS. 2a and 2b is being defined at present in protocol specifications for 3GPP and 3GPP2, although the scope of the invention is intended to include the interworking of other types of WLAN networks and other types of technologies consistent with that described herein either now known or later developed in the future.

In particular, the implementation of the present invention is based on two key aspects:

1) The network uses two layers of beacons (“full beacon” and “reduced beacon”) that are sent depending on the current system load.
a) The full beacon contains a complete set of information the AP needs to broadcast, and is sent at regular intervals when the system traffic load is below a certain threshold (defined by the network administrator with a mechanism that is outside the scope of this invention).
b) The reduced beacon contains a subset of the full beacon information (i.e. only relevant information for e.g. fast roaming, support for some 0.11k measurements etc.) and is sent when the system traffic load is above a certain threshold at the same regular intervals the full beacon was sent, in order to avoid impacting the system capacity.
c) When the system traffic load is above a certain threshold, the full beacon may be sent with less frequency or not be sent at all (this should be left up to the operator to decide).
d) The frequency at which the full and reduced beacon are sent can be left up to the network administrator or specified by 802.11.

2) A two-layer set of information is used, as follows:
a) split the information to be provided to the stations in type-1 and type-2.
b) Information Elements (Ies) are defined for all the information type-1 and all the info type-2.
c) Type-1 information is a semi-static set of Ies, i.e. it does not really change much, therefore even if info type-1 is obtained by the STA through a request/response mechanism (e.g. extended Probe Request/Response messages), the set of Ies is pretty much fixed.
d) Type-2 information is more dynamic, i.e. the “beacon” with type-2 information delivers an adaptive set of Ies (adaptive in the sense that the network decides when and how to modify the content), but when the STA sends a request for such info (e.g. in Probe Request), it can indicate exactly what info it wants, so the response is customized to the STA request.
e) The system is configured, e.g., to send type-1 information (e.g. in beacon) every X ms, and type-2 information every Y ms (X and Y are decided by the entity that is deploying the APs, based on a mechanism that is outside the scope of this invention).
f) if an STA needs the information (either type-1 or type-2) more often (i.e. it did not get it at the last round it was distributed and therefore sends a request), the system monitors such requests and may decide, based on management algorithms, to change the type of information sent and the frequency, i.e. creating an adaptive “advertising” of information.
g) Also, the system can add the information to Neighbor reports in an adaptive fashion.

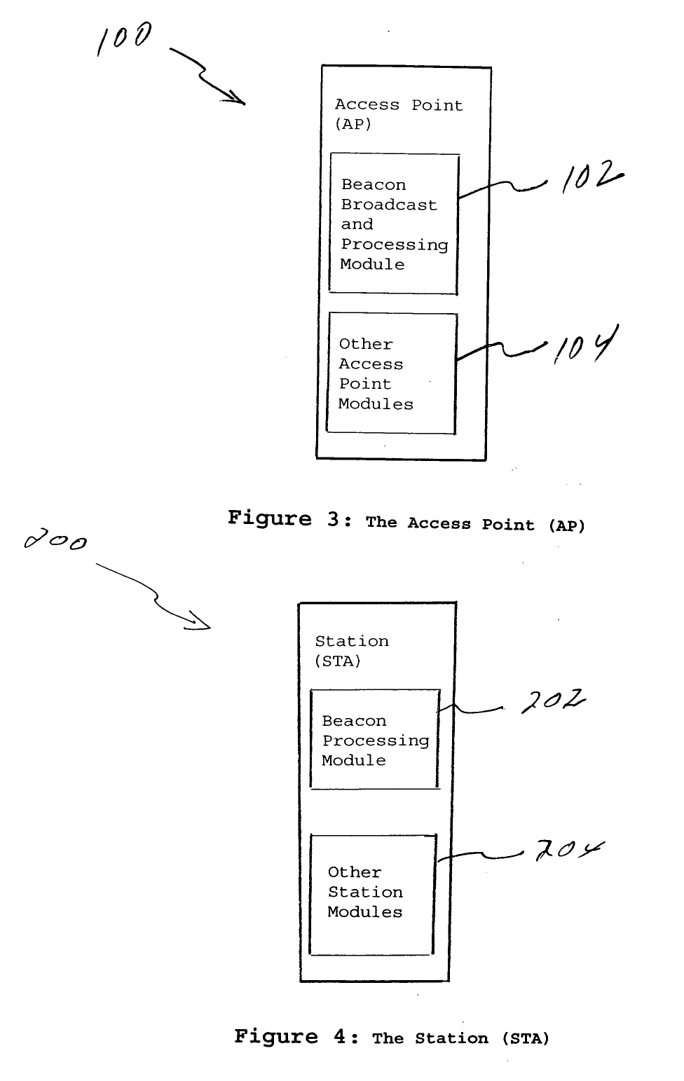

### FIG. 3: The Access Point (AP)

FIG. 3 shows, by way of example, an access point (AP) generally indicated as 100 according to the present invention having a beacon broadcast and processing module 102 and other access point modules 104.

In operation, the beacon broadcast and processing module 102 is configured to layer beacons so as to provide a full beacon and a reduced beacon depending on the current system load in accordance with the present invention and consistent with that described herein. By way of example, the functionality of the module 102 shown in FIG. 3 may be implemented using hardware, software, firmware, or a combination thereof, although the scope of the invention is not intended to be limited to any particular embodiment thereof. In a typical software implementation, the module 102 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the module 102 being a stand alone module in the combination with other circuitry for implementing another module.

The other access point modules 104 and the functionality thereof are known in the art, do not form part of the underlying invention per se, and are not described in detail herein.

### FIG. 4: The Station (STA)

FIG. 4 shows, by way of example, a station (STA) generally indicated as 200 according to the present invention having a beacon processing module 202 and other station modules 204.

In operation, the beacon processing module 202 may be configured to receive such a beacon signal discussed above and/or provide request for such information, including in a probe request, where the STA can indicate exactly what information it wants, so the response is customized to the request by the STA. By way of example, the functionality of the module 202 shown in FIG. 4 may be implemented using hardware, software, firmware, or a combination thereof, although the scope of the invention is not intended to be limited to any particular embodiment thereof. In a typical software implementation, the module 202 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the module 202 being a stand alone module in the combination with other circuitry for implementing another module.

The other station modules 204 and the functionality thereof are known in the art, do not form part of the underlying invention per se, and are not described in detail herein.

### IBSS Networks

The scope of the invention is intended to include using the same in IBSS networks. For example, in an infrastructure network only APs are sending beacons. In IBSS networks, all the STAs can send beacons. Although the IBSS case may not be relevant from an interworking point of view, it is import to note that the scope of the inventions is also intended to include having a two or more stage beaconing scheme in an IBSS network to support some other scenario either now known or later developed in the future.

### Standardization Targets

The invention targets standardization in 802.11, 802.11 TGu, 802.11u and/or IEEE 802.21 specification protocols. Traffic analysis to identify the message exchanges between an associating STA and the AP will reveal whether the solution is being implemented in the STA, the AP or both.

### ADVANTAGES AND DISADVANTAGES

Advantages of the present invention include the following:
The invention allows efficient distribution of required information; and
By adding a layering of beacons/information, the impact on system capacity due to the new bits added to the beacon is kept minimal.

Disadvantages of the present invention may include the following:
The solution introduces some additional complexity; and
One may think that the exchange of information before the STA is actually authenticated with the AP may introduce security issues, specifically due to the fact that the information is not authenticated (so that a man-in-the-middle rogue AP may generate false information, or that a rogue STA may generate an unreasonable number of requests. However, in both cases the issues are not worst than with current Probe Request/Response messages, since they are not authenticated and there is no limit to the number of requests from the STA.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

We claim:

1. A method for interworking between a Wireless Local Area Network (WLAN), including that defined in IEEE 802.11 Standard Protocol, and one or more other networks, including a 3GPP, 3GPP2 or IEEE 802.16), wherein the method comprises:
layering beacons so as to provide a first beacon having a set of information the access point (AP) needs to broadcast and a second beacon having a reduced set of information depending on the current system load.

2. A method according to claim 1, wherein the first beacon is a full beacon containing a complete set of information the access point (AP) needs to broadcast and is sent at regular intervals when the system traffic load is below a certain threshold that is defined by a network administrator or specified by some other suitable mechanism.

3. A method according to claim 1, wherein the second beacon is a reduced beacon containing a subset of the information contained in the first beacon and is sent when the system traffic load is above a certain threshold at the same regular intervals the first beacon was sent in order to avoid impacting the system capacity.

4. A method according to claim 2, wherein the full beacon includes only relevant information, including information related to fast roaming, support for some 0.11k measurements, etc.

5. A method according to claim 1, wherein the layering of beacons includes using a two-layer set of information, including splitting the information to be provided to one or more stations (STA) in type-1 information and type-2 information.

6. A method according to claim 5, wherein information elements (Ies) are defined for all the type-1 information and all the type-2 information.

7. A method according to claim 6, wherein the type-1 information is a semi-static set of the Ies.

8. A method according to claim 6, wherein the type-2 information is a more dynamic set of information, including providing the reduced beacon with type-2 information having an adaptive set of Ies based on the network deciding when and how to modify the content thereof.

9. A method according to claim 5, wherein the method includes sending the type-1 information and the type-2 information at different time intervals, including sending the type-1 information in the full beacon every X ms, and sending type-2 information in the reduced beacon every Y ms.

10. A method according to claim 9, wherein the method includes the time intervals are decided by an entity that is deploying access points (AP) in the network.

11. A method according to claim 5, wherein the method includes the system monitoring requests by the STA and deciding, based on suitable management algorithms, to change the type of information sent and the frequency of sending the same.

12. A method according to claim 11, wherein the method includes creating an adaptive “advertising” of information—if an STA needs the information (either type-1 or type-2) more often, including if the STA did not get it at the last round it was distributed and therefore sends a request.

13. A network for providing interworking between a Wireless Local Area Network (WLAN), including such as that defined in IEEE 802.11 Standard Protocol, and or one or more other networks, including a 3GPP, 3GPP2 or IEEE 802.16), wherein
the one or more network nodes is configured to layer beacons so as to provide a first beacon having a set of information the access point (AP) needs to broadcast and a second beacon having a reduced set of information depending on the current system load.

14. A network according to claim 13, wherein the first beacon is a full beacon containing a complete set of information the access point (AP) needs to broadcast and is sent at regular intervals when the system traffic load is below a certain threshold that is defined by a network administrator or specified by some other suitable mechanism.

15. A network according to claim 13, wherein the second beacon is a reduced beacon containing a subset of the information contained in the full beacon and is sent when the system traffic load is above a certain threshold at the same regular intervals the full beacon was sent in order to avoid impacting the system capacity.

16. A network according to claim 14, wherein the full beacon includes only relevant information, including information related to fast roaming, support for some 0.11k measurements, etc.

17. A network according to claim 13, wherein the layering of beacons includes using a two-layer set of information, including splitting the information to be provided to one or more stations (STA) in type-1 information and type-2 information.

18. A network according to claim 17, wherein information elements (Ies) are defined for all the type-1 information and all the type-2 information.

19. A network according to claim 18, wherein the type-1 information is a semi-static set of the Ies.

20. A network according to claim 18, wherein the type-2 information is a more dynamic set of information, including providing the reduced beacon with type-2 information having an adaptive set of Ies based on the network deciding when and how to modify the content thereof.

21. A network according to claim 17, wherein the network node sends the type-1 information and the type-2 information at different time intervals, including sending the type-1 information in the full beacon every X ms, and sending type-2 information in the reduced beacon every Y ms.

22. A network according to claim 21, wherein the time intervals for sending the same are decided by an entity that is deploying access points (AP) in the network.

23. A network according to claim 17, wherein the network node or other suitable node in the network monitors requests by the STA and decides, based on suitable management algorithms, to change the type of information sent and the frequency of sending the same.

24. A network according to claim 23, wherein the layer of beacons includes creating an adaptive “advertising” of information—if an STA needs the information (either type-1 or type-2) more often, including if the STA did not get it at the last round it was distributed and therefore sends a request.

25. A network node for providing interworking between a Wireless Local Area Network (WLAN), including that defined in IEEE 802.11 Standard Protocol, and or one or more other networks, including a 3GPP, 3GPP2 or IEEE 802.16), wherein
the one or more network nodes is configured to layer beacons so as to provide a first beacon having a set of information the access point (AP) needs to broadcast and a second beacon having a reduced set of information depending on the current system load.

26. A network node according to claim 25, wherein the first beacon is a full beacon containing a complete set of information the access point (AP) needs to broadcast and is sent at regular intervals when the system traffic load is below a certain threshold that is defined by a network administrator or specified by some other suitable mechanism.

27. A network node according to claim 25, wherein the second beacon is a reduced beacon contains a subset of the information contained in the full beacon and is sent when the system traffic load is above a certain threshold at the same regular intervals the full beacon was sent in order to avoid impacting the system capacity.

28. A network node according to claim 26, wherein the full beacon includes only relevant information, including information related to fast roaming, support for some 0.11k measurements, etc.

29. A network node according to claim 25, wherein the layering of beacons includes using a two-layer set of information, including splitting the information to be provided to one or more stations (STA) in type-1 information and type-2 information,

30. A network node according to claim 29, wherein information elements (Ies) are defined for all the type-1 information and all the type-2 information.

31. A network node according to claim 30, wherein the type-1 information is a semi-static set of the Ies.

32. A network node according to claim 30, wherein the type-2 information is a more dynamic set of information, including providing the reduced beacon with type-2 information having an adaptive set of Ies based on the network deciding when and how to modify the content thereof.

33. A network node according to claim 29, wherein the network node sends the type-1 information and the type-2 information at different time intervals, including sending the type-1 information in the full beacon every X ms, and sending type-2 information in the reduced beacon every Y ms.

34. A network node according to claim 33, wherein the time intervals are decided by an entity that is deploying access points (AP) in the network.

35. A network node according to claim 29, wherein the network node or other suitable node in the network monitors requests by the STA and deciding, based on suitable management algorithms, to change the type of information sent and the frequency of sending the same.

36. A network node according to claim 35, wherein the method includes creating an adaptive “advertising” of information—if an STA needs the information (either type-1 or type-2) more often, including if the STA did not get it at the last round it was distributed and therefore sends a request.

37. A network node according to claim 27, wherein the network node is an access point (AP).

38. A method according to claim 1, wherein the one or more steps of the method are performed in a computer program running on a processor or other suitable processing device in a network node in the network or system.

39. A computer program product for providing interworking between a Wireless Local Area Network (WLAN), including that defined in IEEE 802.11 Standard Protocol, and or one or more other networks, including a 3GPP, 3GPP2 or IEEE 802.16), wherein the computer program product is configured to layer beacons so as to provide a first beacon having a set of information the access point (AP) needs to broadcast and a second beacon having a reduced set of information depending on the current system load.

40. A method for providing a beacon in a network including a Wireless Local Area Network (WLAN), such as that defined in IEEE 802.11 Standard Protocol, or one or more other networks, including a 3GPP, 3GPP2 or IEEE 802.16), wherein the method comprises:
layering beacons so as to provide a full beacon and a reduced beacon depending on the current system load.

41. A method according to claim 40, wherein the method includes layering the beacons as part of an interworking between the WLAN and the one or more other networks.

42. A method according to claim 40, wherein the one or more steps of the method are performed in a computer program running on a processor or other suitable processing device in a network node in the network or system.

43. A network having one or more network nodes, including a Wireless Local Area Network (WLAN), such as that defined in IEEE 802.11 Standard Protocol, or one or more other networks, including a 3GPP, 3GPP2 or IEEE 802.16), wherein
the one or more network nodes is configured to layer beacons so as to provide a full beacon and a reduced beacon depending on the current system load.

44. A network according to claim 43, wherein the one or more network nodes layer the beacons as part of an interworking between the WLAN and the one or more other networks.

45. A network node that forms part of a Wireless Local Area Network (WLAN), including that defined in IEEE 802.11 Standard Protocol, or one or more other networks, including a 3GPP, 3GPP2 or IEEE 802.16), wherein
the one or more network nodes is configured to layer beacons so as to provide a full beacon and a reduced beacon depending on the current system load.

46. A network node according to claim 45, wherein the one or more network nodes layer the beacons as part of an interworking between the WLAN and the one or more other networks.

47. A computer program product for a network node that forms part of a Wireless Local Area Network (WLAN), including that defined in IEEE 802.11 Standard Protocol, or one or more other networks, including a 3GPP, 3GPP2 or IEEE 802.16), wherein the computer program product is configured to layer beacons so as to provide a full beacon and a reduced beacon depending on the current system load.

48. A computer program product according to claim 47, wherein the computer program product layers the beacons as part of an interworking between the WLAN and the one or more other networks.
